(19) United States
(12) Patent Application Publication
(10) Pub. No.: US 2025/0231043 A1
(43) Pub. Date: Jul. 17, 2025

(54) ESTIMATING 2D GEOSPATIAL BOUNDARIES OF ROAD JUNCTIONS

(71) Applicant: Toyota Jidosha Kabushiki Kaisha, Aichi-ken (JP)

(72) Inventor: James Biagioni, Seattle, WA (US)

(73) Assignee: Toyota Jidosha Kabushiki Kaisha, Aichi-ken (JP)

(21) Appl. No.: 18/411,218

(22) Filed: Jan. 12, 2024

(51) Int. Cl. G01C 21/00; G06F 16/29

(52) U.S. Cl. CPC G01C 21/3819; G06F 16/29

(57) ABSTRACT

A method for estimating a 2D geospatial boundary of a road junction comprises: receiving a road map comprising a first road and a second road; receiving intended use data and geospatial data of the first road and the second road; identifying a first road edge of the first road and a second road edge of the second road; identifying the road junction defined by the first road edge and the second road edge; estimating the 2D geospatial boundary, wherein: the estimating of the 2D geospatial boundary comprises generating a generated junction size using the intended use data of the first road and the second road, and the estimating of the 2D geospatial boundary comprises generating a generated junction shape using the geospatial data of the first road and the second road; and modifying the road map to comprise the 2D geospatial boundary.

### BACKGROUND

### Field

The present disclosure generally relates to estimating two dimensional (“2D”) geospatial boundaries of road junctions, and more specifically, to systems, methods, and non-transitory computer-readable mediums for estimating 2D geospatial boundaries of road junctions.

### Technical Background

Modern vehicles increasingly utilize digital road maps for purposes such as navigation, automated-driving, and determining vehicle routes. Particularly, for purposes such as automated driving, sizes and shapes of features in roads of such road maps can be used to navigate such features by, for example, a vehicle's navigation system or automated driving system. However, junctions of roads (for example, an intersection) can vary in size and shape. Further, sizes and shapes of such road junctions can vary over time, as, for example, roads leading into such junctions (and, thereby, the road junctions themselves) may be modified (for example, widened), thereby changing a size or a shape of such road junctions.

Determining sizes and shapes of road junctions may be difficult to determine from existing road maps, which may not include such data or may not be drawn to scale, or observationally from, for example, on-board vehicle cameras, as such road junctions may not be fully depicted by such cameras due to, for example, their size. Determining sizes and shapes of road junctions from satellite imagery may also be difficult, due to, for example, being computationally expensive or time consuming, being difficult to conduct by humans (due to, for example, the large data sets required to parse to make such determinations on a large scale), requiring difficult- or expensive-to-obtain data sets of such imagery, and irregularity of the updating of such imagery (thereby, for example, not reflecting changes to such road junctions occurring since such imagery was captured).

Accordingly, a need may exist for mechanisms for estimating sizes or shapes of such road junctions.

### SUMMARY

According to a first embodiment, a method for estimating a 2D geospatial boundary of a road junction comprises: receiving a road map comprising a first road and a second road; receiving intended use data and geospatial data of the first road and the second road; identifying a first road edge of the first road and a second road edge of the second road; identifying the road junction, wherein the road junction is defined by the first road edge and the second road edge; estimating the 2D geospatial boundary of the road junction, wherein: the 2D geospatial boundary comprises a generated junction size and a generated junction shape, the estimating of the 2D geospatial boundary comprises generating the generated junction size using the intended use data of the first road and the intended use data of the second road, and the estimating of the 2D geospatial boundary comprises generating the generated junction shape using the geospatial data of the first road and the geospatial data of the second road; and modifying the road map to comprise the 2D geospatial boundary.

According to a second embodiment, a system for road junction 2D geospatial boundary estimation comprises: a memory component, wherein: the memory component stores a road map, the road map comprises a first road and a second road, a first road edge of the first road and a second road edge of the second road, and the memory component further stores intended use data and geospatial data of the first road and the second road; a road data interpreter which receives, from the memory component, the first road edge and the second road edge and identifies a road junction defined by the first road edge and the second road edge; a junction size generator which receives, from the memory component, the intended use data of the first road and the intended use data of the second road and generates a generated junction size using the intended use data of the first road and the intended use data of the second road; a junction shape generator which receives, from the memory component, the geospatial data of the first road and the geospatial data of the second road and generates a generated junction shape using the geospatial data of the first road and the geospatial data of the second road; and a road map modifier which receives, from the junction size generator, the generated junction size and, from the junction shape generator, the generated junction shape and modifies the road map to comprise: the generated junction size, the generated junction shape, or the generated junction size and the generated junction shape.

According to a third embodiment, a non-transitory computer-readable medium stores logic that, when executed by a processor, causes the processor to perform at least the following: receive, from a memory component, a road map comprising a first road, a second road, a first road edge of the first road, a second road edge of the second road edge, and intended use data and geospatial data of the first road and the second road; identifying, by a road data interpreter, a road junction defined by the first road edge and the second road edge; estimating a 2D geospatial boundary of the road junction, wherein: the 2D geospatial boundary comprises a generated junction size and a generated junction shape, the estimating of the 2D geospatial boundary comprises generating, by a junction size generator, the generated junction size using the intended use data of the first road and the intended use data of the second road, and the estimating of the 2D geospatial boundary comprises generating, by a junction shape generator, the generated junction shape using the geospatial data of the first road and the geospatial data of the second road; and modify, by a road map modifier, the road map to comprise the 2D geospatial boundary.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts a plurality of roads and road junctions, according to one or more embodiments shown and described herein;

FIG. 2 schematically depicts a road map including road junctions having unestimated 2D geospatial boundaries, according to one or more embodiments shown and described herein;

FIG. 3 schematically depicts hardware for estimating a 2D geospatial boundary of a road junction, according to one or more embodiments shown and described herein;

FIG. 4 depicts a flow diagram of an illustrative method for estimating a 2D geospatial boundary of a road junction, according to one or more embodiments shown and described herein;

FIG. 5 schematically depicts a step of the method of FIG. 4, according to one or more embodiments shown and described herein;

FIG. 6 schematically depicts a step of the method of FIG. 4, according to one or more embodiments shown and described herein;

FIG. 7 schematically depicts a step of the method of FIG. 4, according to one or more embodiments shown and described herein; and

FIG. 8 schematically depicts a step of the method of FIG. 4, according to one or more embodiments shown and described herein.

### DETAILED DESCRIPTION

The present disclosure, in one form, is related to methods, systems, and non-transitory computer-readable mediums for estimating a two-dimensional (“2D”) geospatial boundary of a road junction, in particular for modifying road maps, such as 2D road maps, to include estimated 2D geospatial boundaries of road junctions. Embodiments of the methods for estimating a 2D geospatial boundary of a road junction described herein may include receiving a road map comprising a first road and a second road, identifying a first road edge of the first road and a second road edge of the second road, identifying a road junction defined by the first road edge and the second road edge, estimating the 2D geospatial boundary of the road junction, and modifying the road map to comprise the 2D geospatial boundary. Embodiments of the systems described herein may be road junction 2D geospatial boundary estimators, which may, in embodiments, comprise a memory component, a junction size generator, a junction shape generator, and a road map modifier. Embodiments of the non-transitory computer-readable mediums described herein store logic that, when executed by a road junction 2D geospatial boundary estimator, may cause the 2D geospatial boundary estimator to: receive a road map comprising a first road and a second road, identify a first road edge of the first road and a second road edge of the second road, identify a road junction defined by the first road edge and the second road edge, estimate a 2D geospatial boundary of the road junction, and modify the road map to comprise the 2D geospatial boundary.

An advantage of the present disclosure is that the various embodiments described herein improve upon typical solutions in that embodiments may provide an automatable method for modifying road maps to include estimated 2D geospatial boundaries of road junctions using, for example, geospatial data and/or intended use data of roads defining such road junctions. Accordingly, using databases comprising such road maps and/or data, embodiments described herein may enable the modification of road maps comprising hundreds, thousands, millions, or even billions of road junctions to include 2D geospatial boundaries.

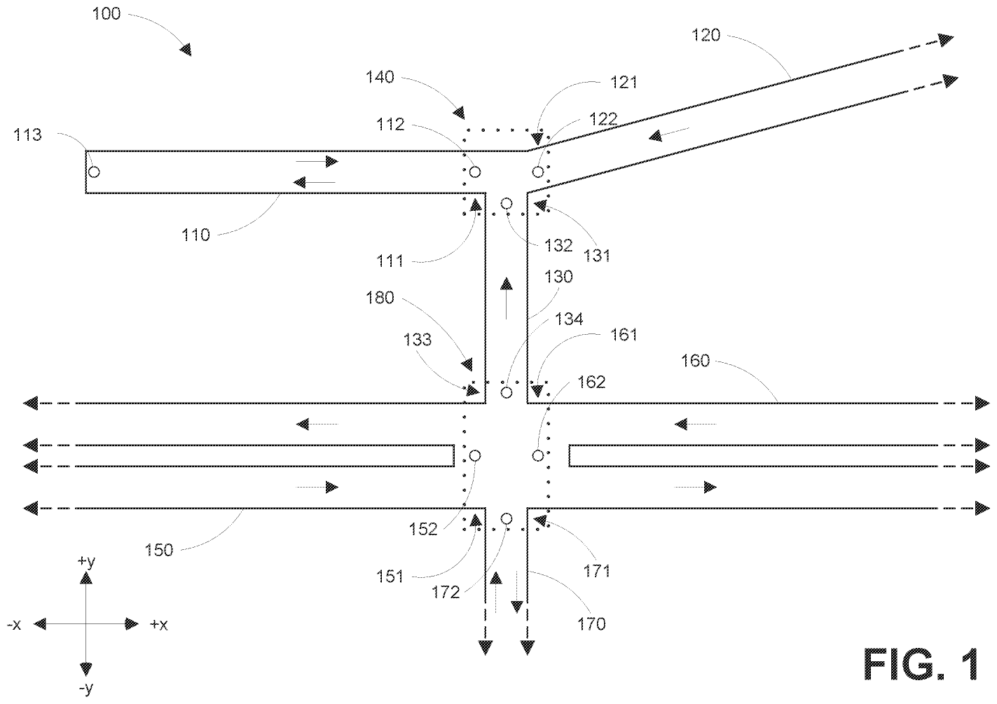

Turning now to the drawings, FIG. 1 schematically depicts a plurality of roads 100. In embodiments, the plurality of roads 100 may include a first road 110, a second road 120, and a third road 130. In the embodiment of FIG. 1, the roads 110, 120, 130 may converge at a first road junction 140 (depicted in FIG. 1 as being within a box denoted by dotted lines). In embodiments, the first road junction 140 is defined by a road edge 111 of the first road 110, a road edge 121 of the second road 120, and a first road edge 131 of the third road 130.

It should be understood that the term “road” as used herein refers to some or all of any road, street, lane, highway, boulevard, alley, byway, parkway, motorway, path, pathway, cycleway, residential road, living street, access road, track, busway, escape, raceway, footway, bridleway, parking lane, bicycle road, any combination thereof, or other such surface which may be traversed by a vehicle (for example, a bicycle, motorcycle, car, moped, or other such vehicle), a human (for example, traveling on foot), or an animal (for example, a horse ridden by a human). It should further be understood that the term “road,” as used herein, refers exclusively to segments between “road junctions.” Accordingly, it should be understood that the term “road junction” as used herein refers to a space defined by an intersection of roads (for example, the roads 110, 120, 130). Despite being depicted in, for example, FIG. 1 as being substantially rectangular, it should be understood that a road junction may be any shape (for example, round, in the case of a roundabout) or may otherwise have other features not depicted in the figures of this application (for example, an unpaved grassy space in the middle of a road junction). Accordingly, while the term “road,” as the term may be used typically, may refer to, for example, a paved section including such road junctions, the term “roads” as used herein includes only segments of the paved section between such road junctions. For example, the roads 110, 120 may each be segments of a north-to-south street named “Broadway” separated by the first road junction 140 defined by the intersection of Broadway and an east-to-west street named “Wall Street.” However, while Broadway may have the same name (and, thereby, considered the same “road,” as the term may be used typically), Broadway instead includes two “roads,” as the term is used herein—the first road 110 (which, in this example, is the segment of Broadway extending southward from the first road junction 140 defined by the intersection of Broadway and Wall Street) and the second road 120 (which, in this example, is the segment of Broadway extending northward from the first road junction 140 defined by the intersection of Broadway and Wall Street). Accordingly, the term “road,” as used herein and in this example, refers only to the segments of Broadway (that is to say, the roads 110 and 120, and, for example, any other segments of Broadway not depicted) between the road junction defined by the intersection of Broadway and Wall Street and either or both of another road junction and/or an end of Broadway.

Accordingly, referring again to the embodiment of FIG. 1, the first road junction 140 is not a portion of any of the roads 110, 120, 130. Rather, in embodiments, the first road junction 140 is a space separate from the roads 110, 120, 130 and defined by the road edge 111 of the first road 110, the road edge 121 of the second road 120, and the first road edge 131 of the third road 130. In the embodiment of FIG. 1, in addition to converging with the roads 110, 120 at the first road junction 140, the third road 130 also converges with a fourth road 150, a fifth road 160, and a sixth road 170 at a second road junction 180. In embodiments, the second road junction 180 may be defined by a second road edge 133 of the third road 130, a road edge 151 of the fourth road 150, a road edge 161 of the fifth road 160, and a road edge 171 of the sixth road 170.

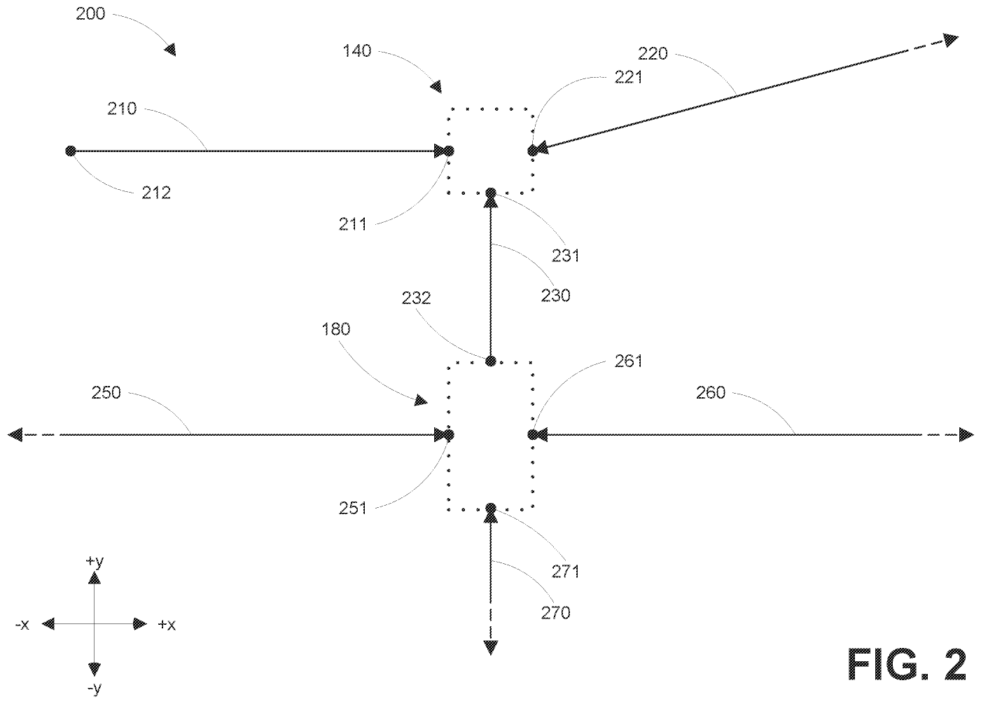

Referring now to FIG. 2, and with reference to FIG. 1, a road map 200 may be a schematic diagram depicting simplified representations of the plurality of roads 100. In the embodiment of FIG. 2, the road map 200 schematically depicts a first road representation 210 representing the first road 110, a second road representation 220 representing the second road 120, a third road representation 230 representing the third road 130, a fourth road representation 250 representing the fourth road 150, a fifth road representation 260 representing the fifth road 160, and a sixth road representation 270 representing the sixth road 170. Accordingly, in embodiments, each of the road representations 210, 220, 230, 250, 260, 270 may be a diagrammatic equivalent of a respective one of the roads 110, 120, 130, 150, 160, 170, and so, in embodiments, the road map 200 may thereby comprise any, some, or all of the roads 110, 120, 130, 150, 160, 170 as any, some, or all of the road representations 210, 220, 230, 250,260, 270.

In embodiments, the road map 200 may be used for or in, for example, navigation for a vehicle, autonomous driving of a vehicle (such as by providing distance parameters for an autonomous vehicle navigating a road junction and/or a road, such as any, some, or all of the roads 110, 120, 130, 150, 160, 170 and/or either or both of the road junctions 140, 180), or in other applications for vehicle operation. For example, the road map 200 may provide a mechanism for routing a vehicle (for example, by a navigation system), as an input for an autonomous driving system to determine how to navigate a road and/or a road junction (such as any, some, or all of the roads 110, 120, 130, 150, 160, 170 and/or either or both of the road junctions 140, 180), and/or for determining a vehicle route (for example, by identifying the location of a road junction and/or of intersecting roads defining a road junction).

In the embodiment of FIG. 2, the road representations 210, 220, 230, 250, 260, 270 may begin and/or end at start points and/or end points which may, in embodiments, correspond to coordinates (for example, latitudinal and longitudinal coordinates), as, in embodiments, the road map 200 may be a representation of the plurality of roads 100 and areas surrounding the same drawn to scale. For example, referring again to FIG. 1, the first road 110, in the embodiment of FIG. 1, extends between road edge coordinates 112, located at the road edge 111, and road start coordinates 113, located at a beginning of the first road 110.

Accordingly, referring now to FIGS. 1 and 2, the first road representation 210, in the embodiment of FIG. 2, extends between a first road end point 211, which may correspond to the road edge coordinates 112 of the first road 110 (by, for example, being positioned at x- and y-coordinate values of the road map 200 corresponding to latitudinal and longitudinal coordinates of the road edge coordinates 112 of the first road 110), and a first road start point 212, which may correspond to the road start coordinates 113 of the first road 110. Accordingly, in embodiments, the first road end point 211 may be a diagrammatic equivalent of the road edge 111 of the first road 110, and so, in embodiments, the road map 200 may thereby comprise the first road 110 as the first road representation 210. In embodiments, the first road representation 210 may, thereby, be a vector (defined in, for example, the x/y plane of FIG. 2) extending from the first road start point 212 to the first road end point 211. In embodiments, a second road end point 221 may correspond to road edge coordinates 122 of the second road 120. Accordingly, in embodiments, the second road end point 221 may be a diagrammatic equivalent of the road edge 121 of the second road 120, and so, in embodiments, the road map 200 may thereby comprise the second road 120 as the second road representation 220. In embodiments, the second road representation 220 may, thereby, be a vector extending from a second road start point (not depicted) to the second road end point 221. In embodiments, a third road end point 231 may correspond to first road edge coordinates 132 of the third road 130. In embodiments, a third road start point 232 may correspond to second road edge coordinates 134 of the third road 130. Accordingly, in embodiments, the third road end point 231 may be a diagrammatic equivalent of the first road edge 131 of the third road 130 and the third road start point 232 may be a diagrammatic equivalent of the second road edge 133 of the third road 130, and so, in embodiments, the road map 200 may thereby comprise the third road 130 as the third road representation 230. In embodiments, the third road representation 230 may, thereby, be a vector extending from the third road start point 232 to the third road end point 231, or, in other embodiments, the third road representation 230 may be a vector extending from the third road end point 231 to the third road start point 232. In embodiments, a fourth road end point 251 may correspond to road edge coordinates 152 of the fourth road 150. Accordingly, in embodiments, the fourth road end point 251 may be a diagrammatic equivalent of the road edge 151 of the fourth road 150, and so, in embodiments, the road map 200 may thereby comprise the fourth road 150 as the fourth road representation 250. In embodiments, the fourth road representation 250 may, thereby, be a vector extending from a fourth road start point (not depicted) to the fourth road end point 251. In embodiments, a fifth road end point 261 may correspond to road edge coordinates 162 of the fifth road 160. Accordingly, in embodiments, the fifth road end point 261 may be a diagrammatic equivalent of the road edge 161 of the fifth road 160, and so, in embodiments, the road map 200 may thereby comprise the fifth road 160 as the fifth road representation 260. In embodiments, the fifth road representation 260 may, thereby, be a vector extending from a fifth road start point (not depicted) to the fifth road end point 261. In embodiments, a sixth road end point 271 may correspond to road edge coordinates 172 of the sixth road 170. Accordingly, in embodiments, the sixth road end point 271 may be a diagrammatic equivalent of the road edge 171 of the sixth road 170, and so, in embodiments, the road map 200 may thereby comprise the sixth road 170 as the sixth road representation 270. In embodiments, the sixth road representation 270 may, thereby, be a vector extending from a sixth road start point (not depicted) to the sixth road end point 271. Accordingly, the first road junction 140 may be defined, in the road map 200, by the road end points 211, 221, 231, and, in embodiments, the second road junction 180 may be defined, in the road map 200, by the road start point 232 and the road end points 251, 261, 271.

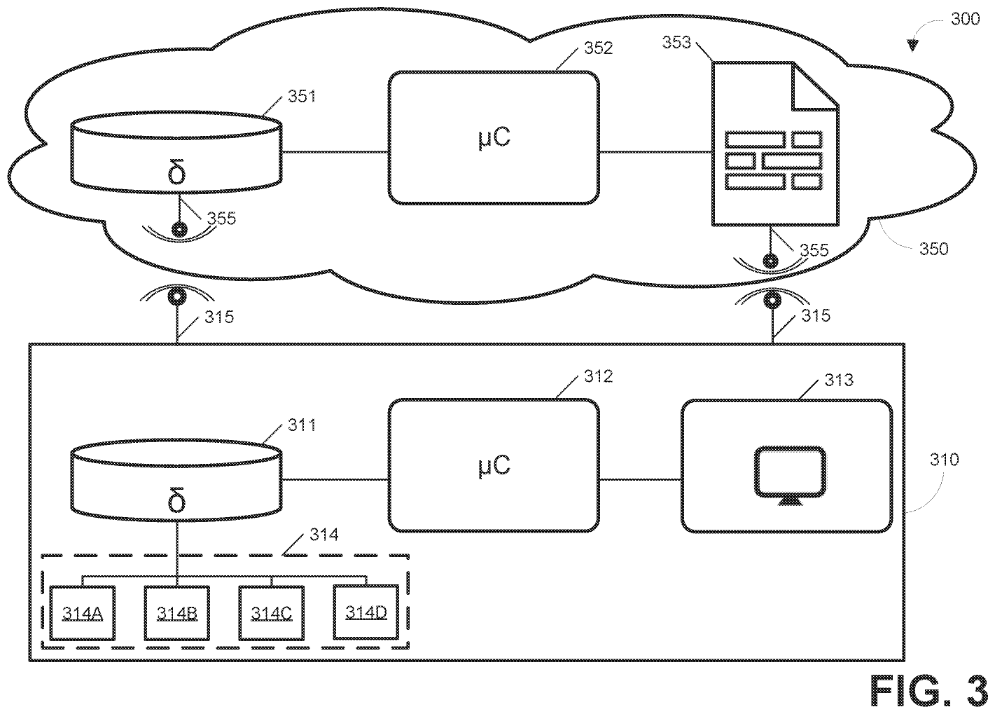

In embodiments, the road map 200 may be a 2D digital map stored on a memory component and modifiable by, for example, components, algorithms, and/or modules described herein. Referring to FIG. 3, in embodiments, a system 300 for road junction 2D geospatial boundary estimation may include a computing device 310. In embodiments, the computing device 310 may include a memory component 311 (for example, a non-transitory computer-readable medium and/or a data memory), a road junction 2D geospatial boundary estimation input monitor 312, a user interface 313 (for example, a digital and/or physical interface by which a user may interact with and/or instruct the computing device 310), and/or subsystems 314 for estimating a 2D geospatial boundary of a road junction. In embodiments, the computing device 310 may include or be coupled (via, for example, Wi-Fi, WiMax, LTE, 4G, 5G, 6G, Bluetooth, Zigbee, and/or other wired and/or wireless connection systems) to one or more transceivers 315 (any, some, or all of which may, in embodiments, be configured as a transmitter, receiver and/or a transceiver) via which the computing device 310 may, in embodiments, receive information about the plurality of roads 100, such as, in embodiments, geospatial data (as described in further detail elsewhere herein) about any, some, or all of the roads of the plurality of roads 100 and/or intended use data (as described in further detail elsewhere herein) about any, some, or all of the roads of the plurality of roads 100. Depending on the embodiment, the computing device 310 may receive information from dozens, hundreds, or even thousands of different pieces of hardware storing information (for example, geospatial data and/or intended use data) about hundreds, thousands, or even millions of roads.

In embodiments, the memory component 311 (denoted in FIG. 3 as 8) may store data corresponding to the road map 200, one or more other road maps, and/or information (for example, geospatial data and/or intended use data) about any, some, or all of the plurality of roads 100 received by the computing device 310 (via, in embodiments, the transceivers 315). Depending on the particular embodiment, the memory component 311 may be configured as random access memory (RAM), read only memory (ROM), registers, a database, and/or other hardware for storing data corresponding to the road map 205, one or more other road maps, and/or data (for example, geospatial data and/or intended use data) about, any, some, or all of the plurality of roads 100. As such, the memory component 311 may be part of a broader memory component of the computing device 310, a data storage component, and/or part of other data storage infrastructure. In embodiments, the memory component 311 may store the subsystems 314 as, for example, logic. However, in other embodiments, the subsystems 314 may be stored in another data memory and/or may include hardware. In embodiments, any, some, or all of the subsystems 314 (for example, any, some, or all of a junction size generator 314A, a junction shape generator 314B, a road map modifier 314C, and/or a road data interpreter 314D, as described in further detail elsewhere herein) may be, include, or store logic which performs the functions of each respective subsystem of the subsystems 314, as described elsewhere herein.

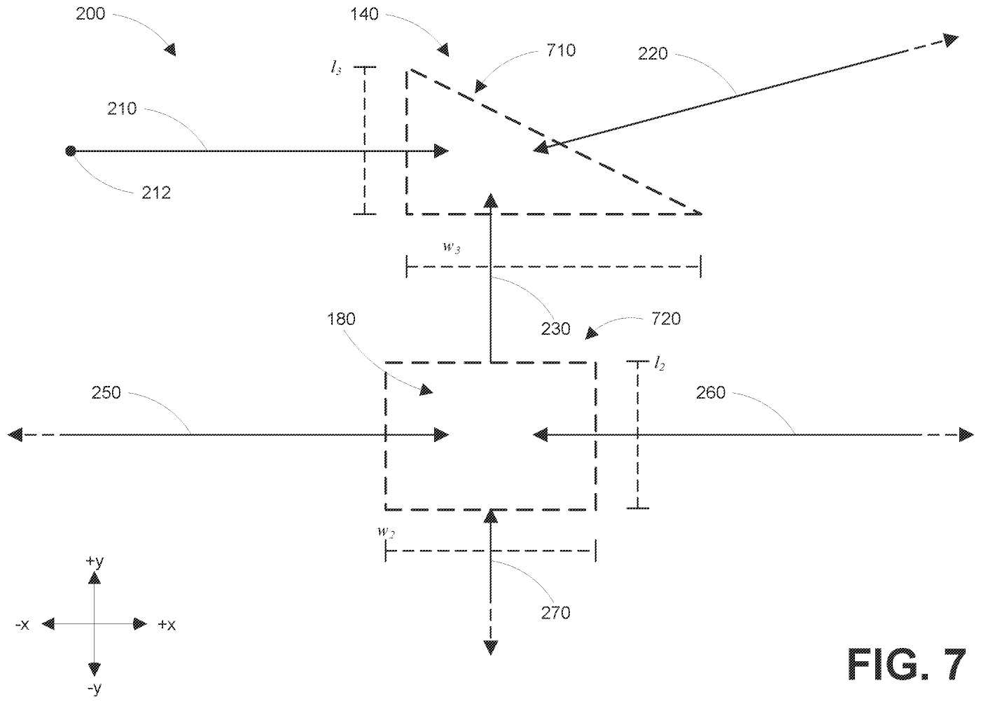

The 2D geospatial boundary estimation input monitor 312 (denoted in FIG. 3 as μC), in embodiments, may represent software operations that are performed on the data corresponding to the road map 200, other road maps, and/or information about any, some, or all of the plurality of roads 100 (for example, geospatial data and/or intended use data) obtained by the transceivers 315. The memory component 311 may store logic (such as, in embodiments, any, some, or all of subsystems 314, as described elsewhere herein) which, when executed by the 2D geospatial boundary estimation input monitor 312, may cause the system 300 to perform any, some, or all of receiving a road map (for example, the road map 200) comprising a first road (for example, the first road representation 210) and a second road (for example, the second road representation 220), identifying a first road edge of the first road (for example, by identifying the first road end point 211 as the road edge 111 of the first road 110) and a second road edge of the second road (for example, by identifying a second road end point 221 as the road edge 121 of the second road 120), identifying a road junction (for example, the first road junction 140), receiving intended use data and geospatial data of the first road and the second road, estimating a 2D geospatial boundary of the road junction (for example, a first 2D geospatial boundary 710, as depicted in FIG. 7 and described in further detail elsewhere herein), and modifying the road map to comprise the 2D geospatial boundary.

In embodiments, the system 300 may include a remote computing device 350. In embodiments, the remote computing device 350 may include any, some, or all of a remote memory component 351, a remote 2D geospatial boundary estimation input monitor 352, a remote 2D geospatial boundary output translator 353, and one or more transceivers 355. In embodiments, the remote memory component 351 may perform and/or provide any, some, or all of the functions of the memory component 311, as described elsewhere herein, separately from, parallel to, and/or in coordination with the memory component 311. In embodiments, the remote 2D geospatial boundary estimation input monitor 352 may perform and/or provide any, some, or all of the functions of the 2D geospatial boundary estimation input monitor 312, as described elsewhere herein, separately from, parallel to, and/or in coordination with the 2D geospatial boundary estimation input monitor 312. Accordingly, the remote computing device 350 may be coupled (via, for example, Wi-Fi, WiMax, LTE, 4G, 5G, 6G, Bluetooth, Zigbee, and/or other wired and/or wireless connection systems) to the computing device 310 by, for example, the transceivers 315, 355, and thereby may, in embodiments, provide cloud computing functions for the computing device 310. In embodiments, the 2D geospatial boundary output translator 353 may include any, some, or all of the subsystems 314. In embodiments, the 2D geospatial boundary output translator 353 may conduct any, some, or all of the functions of the subsystems 314 separately from, parallel to, and/or in coordination with the subsystems 314. In embodiments, the system 300 may include only one of each of the computing devices 310, 350, or one or more of either or both of the computing devices 310, 350.

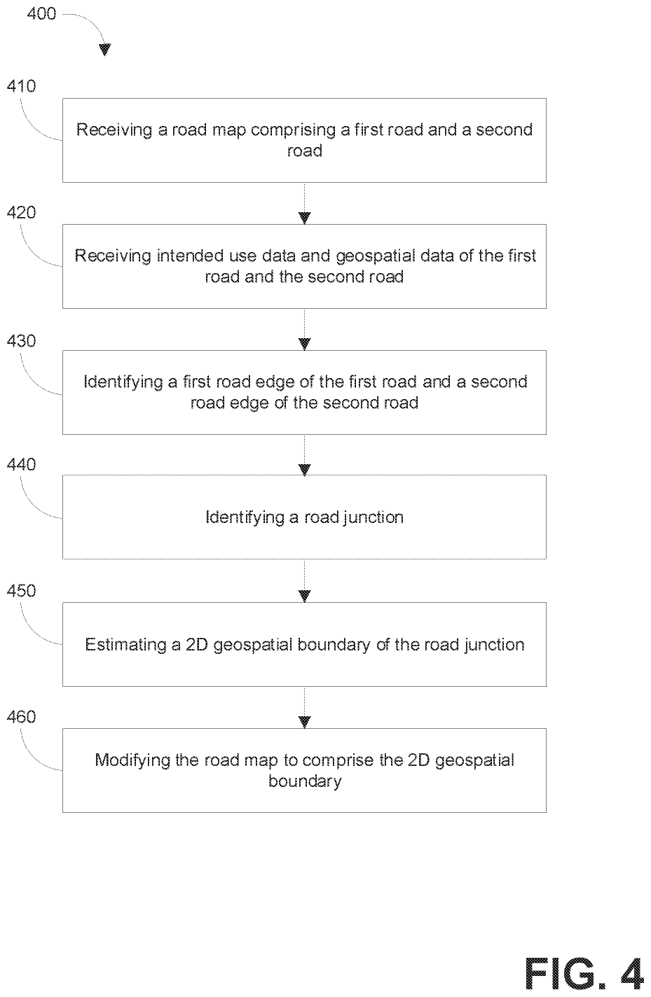

In embodiments, any, some, or all of the steps of methods described herein (for example, embodiments of a method 400 depicted in FIG. 4 and described in further detail elsewhere herein) may be conducted by the remote computing device 350 and separately from, parallel to, and/or in coordination with the computing device 310. In embodiments, the subsystems 314 and/or any, some, or all of the components thereof (for example, any, some, or all of a junction size generator 314A, a junction shape generator 314B, a road map modifier 314C, and/or a road data interpreter 314D, as described in further detail elsewhere herein) may include and/or be configured as any, some, or all of hardware, software, and/or non-transitory computer-readable mediums (executed by, for example, either or both of the computing devices 310, 350) which may perform the functions of the subsystems 314 and/or any, some, or all of the components thereof, as described elsewhere herein.

FIG. 4 depicts a flow diagram of an illustrative method 400 of estimating a 2D geospatial boundary of a road junction by, for example, using the various components of the system 300 of FIG. 3 as described herein. While the method 400 of FIG. 4 generally relates to use of the systems described herein, it should be understood that a similar process may be used for other mechanisms for estimating a 2D geospatial boundary of a road junction. Reference will be made generally herein to an embodiment of the method 400 which estimates a first 2D geospatial boundary 710 (as depicted in FIG. 7 and described in further detail elsewhere herein) as a digital representation of the first road junction 140 in the road map 200. However, it should be understood that these embodiments of the method 400 are merely illustrative, and that embodiments of the method 400 may be used to, instead, estimate a second 2D geospatial boundary 720 (as depicted in FIG. 7 and described in further detail elsewhere herein) as a digital representation of the second road junction 180 and/or other 2D geospatial boundaries as digital representations of other road junctions. For example, in embodiments, the method 400 may be utilized to estimate 2D geospatial boundaries of road junctions defined by any plurality of roads, such as, in embodiments, two roads, three roads, four roads, five roads, six roads, or even seven or more roads. Further, embodiments of the method 400 may be utilized to estimate 2D geospatial boundaries of road junctions defined by roads having different geospatial data and/or intended use data (as described in further detail elsewhere herein) than data of any, some, or all of the roads 110, 120, 130, 150, 160, 170 as described herein with respect to the first and second embodiments of the method 400, and embodiments of the method 400 may be utilized to estimate 2D geospatial boundaries defined by pluralities of roads having any combination of roads having any combination of differing geospatial data and/or intended use data. In embodiments, any, some, or all of the steps of the method 400 may be omitted, repeated, and/or otherwise modified in embodiments of the method 400, such as by implementing modifications to such embodiments described elsewhere herein.

Referring to FIG. 4 and with reference to FIGS. 1-3, the method 400 may include receiving the road map 200 comprising a first road and a second road, as depicted in block 410. That is, the road map 200 may comprise roads by comprising digital representations of actual roads, such as by comprising the roads 110, 120 by comprising the road representations 210, 220, respectively. In embodiments, the road map 200 may further comprise the third road 130 by comprising the third road representation 230. In embodiments, the road map 200 may comprise any plurality of roads, such as, in embodiments, two roads, three roads, four roads, five roads, six roads, or even seven or more roads. In embodiments (for example, embodiments wherein either or both of the memory components 311, 31 have previously received the road map 200), either or both of the memory components 311, 351 may store the road map 200 prior to the initiation of the method 400 and, in certain such embodiments, the step of the block 410 may be omitted from the method 400. In embodiments, the memory component 311 may receive the road map 200 from the remote computing device 350 (via, for example, the transceiver 315). In embodiments, the remote memory component 351 may receive the road map 200 from the computing device 310 (via, for example, the transceiver 355.

Referring again to FIG. 4 and with reference to FIGS. 1-2, the method 400 may include receiving intended use data and geospatial data of the first road 110 and the second road 120, as depicted in block 420. In embodiments, the step of the method 400 may include receiving only intended use data of either or both of the roads 110, 120. In embodiments, the step of the method 400 may include receiving only geospatial data of either or both of the roads 110, 120. In embodiments, the method 400 may further include receiving intended use data and/or geospatial data of the third road 130. In embodiments, the step of the block 420 may include receiving any combination of geospatial data and/or intended use data of one road and/or any plurality of roads, such as, in embodiments, two roads, three roads, four roads, five roads, six roads, or even seven or more roads.

In embodiments, intended use data of a road may include one or more classifications of the road. In embodiments, a classification of a road may include a context of a road. For example, a classification of a road may include an identification of whether the road is in a residential area, an urban area, a transit area, or another such area. In embodiments, a classification of a road may include a classification of the road itself. In embodiments, a classification of a road may include any, some, or all of a motorway classification (for example, a restricted access divided highway or other large and/or major highway), a motorway link classification (for example, an on-ramp or other linking road between a first road to a motorway), a trunk road classification (for example, a highway that may not be a motorway, such as a highway that is not divided), a trunk link classification (for example, an on-ramp or other linking road between a first road and a trunk road), a primary road classification (for example, a highway that may link large towns), a primary link classification (for example, an on-ramp or other linking road between a first road and a primary road), a secondary road classification (for example, a highway that may link towns), a secondary road link classification (for example, an on-ramp or other linking road between a first road and a secondary road), a tertiary road classification (for example, a highway that may link smaller towns and/or villages), a tertiary link classification (for example, an on-ramp or other linking road between a first road and a tertiary road), a residential classification (for example, a road which serves as an access road for housing and/or housing developments), a living street classification (for example, residential streets where pedestrians have a legal right-of-way over cars and/or residential streets having low speeds), an unclassified classification (for example, roads for which a classification is not stored or otherwise is not identified), a service road classification (for example, access roads or roads within industrial sites, parks, alleys, or other such locations), and/or other classifications. As described in further detail elsewhere herein, intended use data may be used in one or more steps of the method 400.

In embodiments, either or both of the memory components 311, 351 may receive intended use data of one or more roads in the step of the block 420 (for example, intended use data of any, some, or all of the roads 110, 120, 130) and via, for example, the transceivers 315, 355, respectively. In embodiments, either or both of the memory components 311, 351 may store intended use data of one or more roads (for example, intended use data of any, some, or all of the roads 110, 120, 130) prior to the initiation of the method 400 and/or the step of the block 420, and, in certain such embodiments, some or all of the step of the block 420 may be omitted from the method 400.

In embodiments, geospatial data of a road may include any data indicating a position and/or orientation of any, some, or all of a road, such as, in embodiments, coordinates corresponding to locations of a road and/or a directional vector defining a representation of a road. For example, geospatial data of the first road 110 may include either or both of the road coordinates 112, 113, and, as an example, geospatial data of the first road 110 may include a directional vector defining the first road representation 210. In embodiments, geospatial data of a road may be used to, for example, generate road representations in a road map (for example, the road map 200) by, for example, using one or more road coordinates (for example, the road start coordinates 113 and the road edge coordinates 112) to generate one or more road points (for example, the first road points 212, 211, respectively) and thereby to generate a road representation (for example, the first road representation 210). In embodiments, geospatial data of a road may be used to, for example, generate a directional vector defining a road representation in a road map (for example, the road map 200) by, for example, translating two or more road coordinates (for example, the road start coordinates 113 and the road edge coordinates 112) into a coordinate scheme of a road map (for example, the x/y coordinate scheme of the road map 200 depicted in FIG. 2) and generating a directional vector therebetween (for example the directional vector defining the first road representation 210). In embodiments, geospatial data of a road may be used for other purposes, and, in embodiments and as described in further detail elsewhere herein, geospatial data may be used in one or more steps of the method 400.

In embodiments, either or both of the memory components 311, 351 may receive geospatial data of one or more roads (for example, geospatial data of any, some, or all of the roads 110, 120, 130) in the step of the block 420 and via, for example, the transceivers 315, 355, respectively. In embodiments, either or both of the memory components 311, 351 may store geospatial data of one or more roads (for example, geospatial data of any, some, or all of the roads 110, 120, 130) prior to the initiation of the method 400 and/or the step of the block 420, and, in certain such embodiments, some or all of the step of the block 420 may be omitted from the method 400.

Referring again to FIG. 4 and with reference to FIGS. 1-3, the method 400 may include identifying the road edge 111 of the first road 110 and the road edge 121 of the second road 120, as depicted in block 430. In embodiments, the method 400 may further include identifying the first road edge 131 of the third road 130. In embodiments, identifying any, some, or all of the road edges 111, 121, 131 may comprise receiving any, some, or all of the road edge coordinates 112, 122, 132, respectively, and, in embodiments, identifying any, some, or all of the road edge coordinates 112, 122, 132 as any, some, or all of the road end points 211, 221, 231, respectively. In embodiments, any, some, or all of the road edges 111, 121, 131 may be identified by any geospatial data of any, some, or all of the roads 110, 120, 130, including, in embodiments, any, some, or all of the road edge coordinates 112, 122, 132. In embodiments, the road map 200 may, prior to initiation of the method 400 and/or the step of the block 430, already include identification of any, some, or all of the road edges 111, 121, 131 (as, for example, any, some, or all of the road end points 211, 221, 231, respectively), and, in certain such embodiments, the step of the block 430 may be omitted and the step of the block 410 may further include receiving identifications of any, some, or all of the road edges 111, 121, 131.

In embodiments, road edges (for example, any, some, or all of the road edges 111, 121, 131) may be identified by a road data interpreter 314D of the subsystems 314 of the computing device 310 and/or of the remote computing device 350. In embodiments, the road data interpreter 314D may comprise any, some, or all of an AI algorithm, a neural network, a deep neural network, an image classification algorithm, an image detection algorithm, an image tagging algorithm, an image segmentation algorithm, and/or any combination thereof for identifying road edges. In embodiments, any, some, or all of the algorithm(s) of the road data interpreter 314D may, in embodiments, independently and/or separately from, parallel to, and/or collectively with one or more other algorithms of the road data interpreter 314D (if any) identify road edges. In embodiments, the road data interpreter 314D may identify road edges (for example, the road edge 111 of the first road 110) by translating received and/or identified coordinates of such road edges (for example, road edge coordinates 112 of the first road 110) into a coordinate scheme (for example, the x/y coordinate scheme of FIG. 2) of a road map (for example, the road map 200). In embodiments, the road data interpreter 314D may generate coordinates (for example, road edge coordinates 112 of the first road 110) of road edges of roads by processing an image (for example, a satellite image) of such roads using, for example, an image detection algorithm, an image segmentation algorithm, an image tagging algorithm, an image segmentation algorithm, and/or any combination thereof.

In embodiments, road edges (for example, any, some, or all of the road edges 111, 121, 131) may be identified by a user of the user interface 313 and, in embodiments, received by any, some, or all of the memory components 311, 351 and/or the road data interpreter 314D. In embodiments, road edges (for example, any, some, or all of the road edges 111, 121, 131) may be identified by one of the road data interpreter 314D and/or a user of the user interface 313 separately from, parallel to, or in coordination with the other of the road data interpreter 314D or the user of the user interface 313. For example, in embodiments, a user of the user interface 313 may check identifications of road edges identified by the road data interpreter 314D to, for example, check the accuracy of such identifications and, if necessary, modify such identifications.

In embodiments, road edges (for example, any, some, or all of the road edges 111, 121, 131) may be previously identified prior to the initiation of the method 400 and received by either or both of the memory components 311, 351 as, for example, road points (for example, any, some, or all of the road end points 211, 221, 231, respectively). In certain such embodiments, the step of the block 420 may be omitted from the method 400. In embodiments, road edges (for example, any, some, or all of the road edges 111, 121, 131) may be previously identified prior to the initiation of the method 400 and stored by either or both of the memory components 311, 351 as, for example, road points (for example, any, some, or all of the road end points 211, 221, 231, respectively). In certain such embodiments, the step of the block 420 may be omitted from the method 400.

Referring again to FIG. 4 and with reference to FIGS. 1-3, the method 400 may include identifying the first road junction 140, as depicted in block 440. In embodiments, the first road junction 140 may be defined by the road edge 111 of the first road 110 and the road edge 121 of the second road 120. In embodiments, the first road junction 140 may be defined by the road edge 111 of the first road 110, the road edge 121 of the second road 120, and the first road edge 131 of the third road 130. In embodiments, the first road junction 140 may be defined by one road edge or any plurality of road edges of any plurality of roads, such as, in embodiments, two roads, three roads, four roads, five roads, six roads, or even seven or more roads.

In embodiments, road junctions (for example, the first road junction 140) may be identified by the road data interpreter 314D. In embodiments, the road data interpreter 314D may comprise any, some, or all of an AI algorithm, a neural network, a deep neural network, an image classification algorithm, an image detection algorithm, an image tagging algorithm, an image segmentation algorithm, and/or any combination thereof for identifying road junctions. In embodiments, the road data interpreter 314D may identify road junctions (for example, the first road junction 140) by processing proximity of road edges (for example, any, some, or all of the road edges 111, 121, 131, as identified by either or both of the road edge coordinates 112, 122, 132, respectively, and/or the road end points 211, 221, 231, respectively). For example, road edges within a proximity threshold may be determined to collectively define a road junction. Accordingly, in embodiments, the road data interpreter 314D may identify the first road junction 140 defined by any, some, or all of the road edges 111, 121, 131 by determining that any, some, or all of the road edge coordinates 112, 122, 132 and/or any, some, or all of the road end points 211, 221, 231 are within a proximity threshold distance from each other (using, for example, distances calculated via latitudinal and longitudinal coordinates and/or in a coordinate scheme of the road map 200, such as the x/y coordinate scheme of FIG. 2). In embodiments, the road data interpreter 314D may use any geospatial data of one or more roads (for example, any, some, or all of the roads 110, 120, 130) to identify a road junction (for example, the first road junction 140).

In embodiments, such proximity thresholds may be a function of the intended use data of roads of such road edges (for example, intended used data of any, some, or all of the roads 110, 120, 130). For example, in embodiments, each of the roads 110, 120 (and, thereby, the road representations 210, 220) may have intended use data including a secondary road classification, and, thereby, a proximity threshold for determining whether the road end points 211, 221 define the road junction may be a proximity threshold value associated with secondary roads. However, in a further example, the third road 130 (and, thereby, the third road representation 230) may have intended use data including a residential classification. In this example, a residential classification may be associated with a lower proximity threshold than a proximity threshold associated with a secondary road classification, and, accordingly, a proximity threshold for determining whether the road end points 211, 221, 231 define the road junction may be, for example, lower than a proximity threshold associated with a secondary road classification and greater than a proximity threshold associated with a residential classification (calculated by, for example, an averaging function). In embodiments, any, some, or all of the road classifications of intended use data or other types of intended use data (as described elsewhere herein) may be associated with differing proximity threshold values.

In embodiments, road junctions (for example, the first road junction 140) may be identified by a user of the user interface 313 and, in embodiments, received by any, some, or all of the memory components 311, 351 and/or the road data interpreter 314D. In embodiments, road junctions (for example, the first road junction 140) may be identified by one of the road data interpreter 314D and/or a user of the user interface 313 separately from, parallel to, or in coordination with the other of the road data interpreter 314D or the user of the user interface 313. For example, in embodiments, a user of the user interface 313 may check identifications of road junctions identified by the road data interpreter 314D to, for example, check the accuracy of such identifications and, if necessary, modify such identifications.

Referring again to FIG. 4 and with reference to FIGS. 3 and 1 and 5-7, the method 400 may include estimating a first 2D geospatial boundary 710 (as depicted in FIG. 7) of the first road junction 140, as depicted in block 450. In embodiments, estimating the first 2D geospatial boundary 710 may include generating a generated junction size (defined by l₃ and w₃ in the embodiment of FIG. 7, and described in further detail elsewhere herein) of the 2D geospatial boundary 710. In embodiments, estimating the 2D geospatial boundary 710 may include generating a first generated junction shape 610 of the first 2D geospatial boundary 710. In embodiments, estimating the first 2D geospatial boundary 710 may include generating a generated junction size and generating the first generated junction shape 610 of the first 2D geospatial boundary 710.

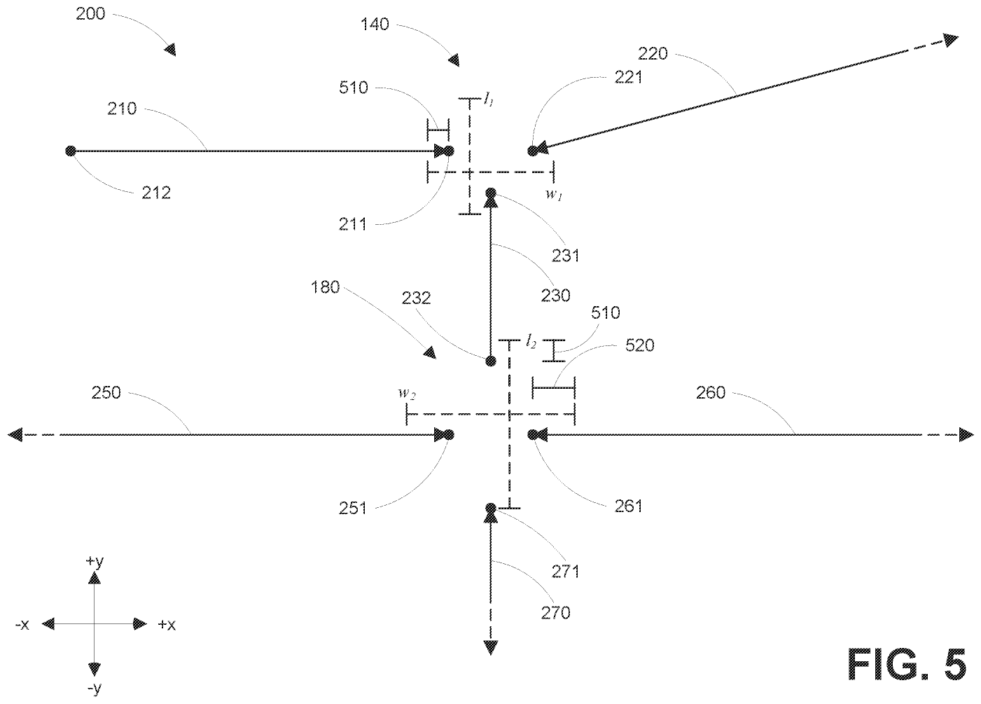

Referring to FIG. 5, in embodiments, the step of the block 450 of the method 400 may include generating a first generated junction size, which, in the embodiment of FIG. 5, is defined by a first junction length l₁ and a first junction width w₁ (hereafter, “the first generated junction size (l₁, w₁)”). While, in the embodiment of FIG. 5, the first generated junction size (l₁, w₁) is a function of the first junction length l₁ and the first junction width w₁, in other embodiments a generated junction size (for example, the first generated junction size (l₁, w₁)) may be a function of one or more metrics (including, in embodiments, any plurality of metrics) including any, some, or all of a junction length, a junction width, and/or any other metric for measuring size in a 2D space (for example, a radius, a circumference, an area, one or more side lengths, or other metrics as may be known in the art).

In embodiments, generating the first generated junction size (l₁, w₁) may include measuring distances between any, some, or all of the road end points 211, 221, 231. However, in embodiments, generating the first generated junction size (l₁, w₁) may comprise using intended use data of any, some, or all of the roads 110, 120, 130 (and, thereby, of any, some, or all of the road representations 210, 220, 230). In embodiments, generating a generated junction size may, in embodiments, comprise generating an offset distance of a road, and, in embodiments, an offset distance of a road may be generated using intended use data of the road. For example, in the embodiment of FIG. 5, generating the first generated junction size (l₁, w₁) may, in embodiments, comprise generating a first offset distance 510 of the first road 110 (and, thereby, the first road representation 210).

In embodiments, an offset distance (such as, for example, the first offset distance 510) may represent a portion of the road estimated to be occupied by the road junction, and may, thereby, be estimated using intended use data of the road, such as, for example, a road classification of the road. For example, a first road junction defined by a motorway may begin prior to a road edge of the motorway defining the junction, a second road junction defined by a residential road may begin prior to the road edge of the residential road defining the junction, and the portion of the first road junction occupied by the motorway may be greater than the portion of the second road junction occupied by the residential road. As another example, an identified road edge of a road may be identified at a location which is in an actual road junction that the road edge defines, and, accordingly, road end points present in a road map, identified in a road map, or otherwise generated in a road map therefrom (for example, the first road end point 211) may not be a wholly accurate indication of a point at which the road ceases and the road junction begins. Further, in such examples, such inaccuracies may be exacerbated by the sizes of roads: for example, a larger road having a motorway classification may be at greater risk and of having a road edge being identified therefrom being within a road junction defined therefrom and being further within a road junction defined therefrom than a smaller road having a residential classification. Accordingly, for any, some, or all of these reasons and/or other reasons, generated junction sizes (for example, the first generated junction size (l₁, w₁)) may, in embodiments, add offset distances (for example, opposite a direction of the road junction along the road) to road edges of roads defining such junctions when generating junction sizes, and, in certain such embodiments, such offset distances may be a function of intended use data of such roads, such as, for example, a road classification.

For example, in the embodiment of FIG. 5, each of the roads 110, 120, 130 (and, thereby, the road representations 210, 220, 230) may have the same road classification, and, in embodiments, the road classification may be associated with a first offset distance 510. Accordingly, as can be seen in FIG. 5, each of the first generated junction length l₁ and the first generated junction width w₁ are not merely distances between the road end points 211, 221, 231 and, instead, include the first offset distance 510 added to either side of each of the first generated junction length l₁ and the first generated junction width w₁. In embodiments, an offset distance (such as, for example, the first offset distance 510 as applied to the first road end point 211) may extend along a road from a road edge of the road in a direction opposite the road junction. However, in embodiments, an offset distance (such as, for example, the first offset distance 510 as applied to the second road end point 221) may not extend along a road from a road edge of the road in a direction opposite the road junction and may, instead, extend from the road edge at an angle relative to the road. For example, in the embodiment of FIG. 5, since the second road representation 220 is not aligned with the first road representation 210 and is, rather than extending parallel to the x-axis of FIG. 5, extending at an angle relative to the x-axis, the offset distance 510 is applied at an angle relative to the second road representation 220. However, in other embodiments, roads at angles relative to one another may each have offset distances applied to road edges thereof in directions opposite the road junction and/or at angles relative to the roads.

In embodiments, differing road classifications of intended use data of a road may be associated with differing offset distances. As an example, in embodiments, such as the embodiment depicted in FIG. 5, the third road 130 (and, thereby, the third road representation 230) may have intended use data including a residential classification, the fifth road 160 (and, thereby, the fifth road representation 260) may have intended use data including a motorway road classification, and the sixth road 170 (and, thereby, the sixth road representation 270) may have intended use data including a living street classification. Accordingly, in that example and as can be seen in the embodiment of FIG. 5, a second generated junction size (l₂, w₂) includes an offset distance 520 of the fifth road representation 260 in a second generated junction width (w₂) greater than the offset distance 510 of the third road representation 230 in a second generated junction length (l₂), while the second generated junction size (l₂, w₂) has no offset distance of the sixth road representation 270 in the second generated junction length (l₂). Accordingly, in embodiments, one or more differing road classifications (such as, in embodiments, any, some, or all of the road classifications described elsewhere herein) may be associated with one or more differing offset distances, including an offset distance of 0 and/or any other offset distance(s).

In embodiments, generating the first generated junction size (l₁, w₁) may comprise using geospatial data of any, some, or all of the roads 110, 120, 130 (and, thereby, geospatial data of any, some, or all of the road representations 210, 220, 230). For example, in embodiments, coordinates of any, some, or all of the roads 110, 120, 130 (for example, any, some, or all of the road coordinates 112, 113, 122, 132) may be used in the generation of the first generated junction size (l₁, w₁). In embodiments, geospatial data of a road may be used to determine an orientation of a road and utilize the orientation of the road in generating a generated junction size. For example, geospatial data of the roads 110, 120 (and, thereby, geospatial data of the road representations 210, 220) may be used to determine an orientation of the second road 120 relative to the first road 110 and using the determined orientation of the second road 120 to, for example, decrease a magnitude of an offset distance of the first generated junction width (w₁) and/or increase a magnitude of the first generated junction length (l₁) using the determined orientation of the second road 120.

In embodiments, generated junction sizes (for example, the first generated junction size (l₁, w₁)) may be generated by a junction size generator 314A of the subsystems 314 of the computing device 310 and/or of the remote computing device 350. In embodiments, the junction size generator 314A may comprise any, some, or all of an AI algorithm, a neural network, a deep neural network, any other algorithm, and/or any combination thereof for generating generated junction sizes. In embodiments, any, some, or all of the algorithm(s) of the junction size generator 314A may, in embodiments, independently and/or separately from, parallel to, and/or collectively with one or more other algorithms of the junction size generator 314A (if any) generate generated junction sizes. In embodiments, the junction size generator 314A may generate generated junction sizes (for example, the first generated junction size (l₁, w₁)) by using either or both of intended use data and/or geospatial data of one or more roads (for example, any, some, or all of the roads 110, 120, 130).

In embodiments, generated junction sizes (for example, the first generated junction size (l₁, w₁)) may be generated by a user of the user interface 313 and, in embodiments, received by any, some, or all of the memory components 311, 351 and/or the junction size generator 314A. In embodiments, generated junction sizes (for example, the first generated junction size (l₁, w₁)) may be generated by one of the junction size generator 314A and/or a user of the user interface 313 separately from, parallel to, or in coordination with the other of the junction size generator 314A or the user of the user interface 313.

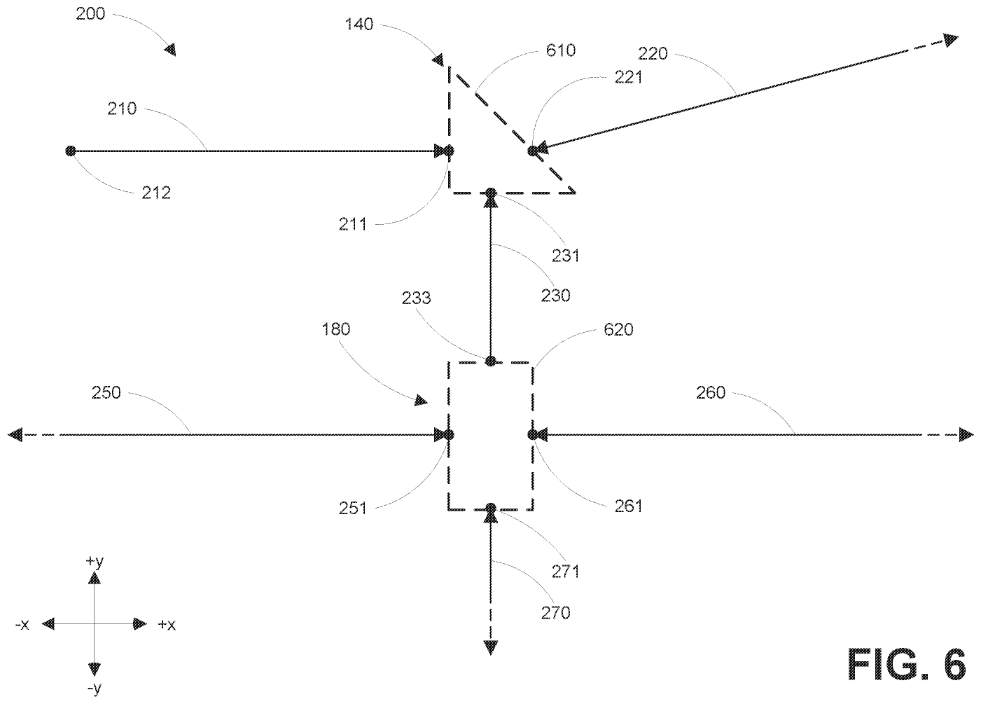

Referring to FIG. 6, in embodiments, the step of the block 450 of the method 400 may include generating a first generated junction shape 610. In embodiments, a generated junction shape may be a polygon; for example, in the embodiment of FIG. 5, the first generated junction shape 610 is a triangle. In embodiments, a polygon of a generated junction shape may have sides equaling a number of road edges (and, thereby, road end points) defining a road junction. In the embodiment of FIG. 5, the first generated junction shape 610 has three sides because, for example, the first road junction 140 is defined by three road edges, while a second generated junction shape 620 has four sides, since the second road junction 180 is defined by four road edges. However, in other embodiments, a generated junction shape may be a polygon having a greater number of sides or a lesser number of sides than a number of road edges defining a road junction thereof. In embodiments, a generated junction shape may not be a polygon, but may, rather, be any other shape, such as, for example, a circle or an irregular shape.

In embodiments, the generating of the first generated junction shape 610 may include using geospatial data of any, some, or all of the roads 110, 120, 130 (and, thereby, any, some, or all of the road representations 210, 220, 230). For example, coordinates of points of a road (for example, any, some, or all of the road coordinates 112, 113, 122, 132) and/or a directional vector defining a representation of a road (for example, any, some, or all of the road representations 210, 220, 230) may be used to determine either or both of a position of a boundary of a generated junction shape and/or an orientation of a boundary of a generated junction shape. For example, in the embodiment of FIG. 5, a side of the first generated junction shape 610 intersecting the second road end point 221 may be angled between the x- and y-axes of FIG. 6 while a side of the first generated junction shape 610 intersecting the first road end point 211 may be parallel to the y-axis of FIG. 6, because, for example, a directional vector defining the first road representation 210 may be parallel to the x-axis while a directional vector defining the second road representation 220 may be angled relative to the x- and y-axes.

In embodiments, generated junction shapes (for example, the first generated junction shape 610) may be generated by a junction shape generator 314B of the subsystems 314 of the computing device 310 and/or of the remote computing device 350. In embodiments, the junction shape generator 314B may comprise any, some, or all of an AI algorithm, a neural network, a deep neural network, any other algorithm, and/or any combination thereof for generating generated junction shapes. In embodiments, any, some, or all of the algorithm(s) of the junction shape generator 314B may, in embodiments, independently and/or separately from, parallel to, and/or collectively with one or more other algorithms of the junction shape generator 314B (if any) generate generated junction shapes. In embodiments, the junction shape generator 314B may generate generated junction shapes (for example, the first generated junction shape 610) by using geospatial data of one or more roads (for example, any, some, or all of the roads 110, 120, 130).

In embodiments, generated junction shapes (for example, the first generated junction shape 610) may be generated by a user of the user interface 313 and, in embodiments, received by any, some, or all of the memory components 311, 351 and/or the junction shape generator 314B. In embodiments, generated junction shapes (for example, the first generated junction shape 610) may be generated by one of the junction shape generator 314B and/or a user of the user interface 313 separately from, parallel to, or in coordination with the other of the junction shape generator 314B or the user of the user interface 313.

Referring to FIGS. 5-7, in embodiments, after generating a generated junction shape of a 2D geospatial boundary, one or more metrics of a generated junction size of a 2D geospatial boundary may be modified to accommodate parameters of the generated junction shape, as, in embodiments, differing geometries of differing generated junction shapes may be optimized by modifying an initially generated junction size. For example, generated junction sizes defined in terms of length and width may be optimized for non-rectangular generated junction shapes by modifying either or both of the length and width of the generated junction size. In the embodiment of FIG. 7, the 2D geospatial boundary 710 includes the triangular shape of the first generated junction shape 610, but, rather than including the first generated junction size (l₁, w₁), the 2D geospatial boundary 710 includes a modified generated junction size (l₃, w₃) defined by a modified generated junction length (l₃) differing from the first generated junction length (l₁) and a modified generated junction width (w₃) differing from the first generated junction width (w₁). However, in other embodiments, any, some, or all metrics (for example, the second generated junction length (l₂) and/or the second generated junction width (w₂)) defining a generated junction size (for example, the second generated junction size (l₂, w₂)) may not be modified after generating a generated junction shape (for example, the second generated junction shape 620). For example, since the second generated junction shape 620 is a rectangle, and since the second generated junction size (l₂, w₂) is a rectangle, a second 2D geospatial boundary 720 may include the second generated junction length (l₂) and the second generated junction width (w₂) rather than, for example, a modified junction length and/or a modified junction width. In embodiments, a generated junction size may not be modified regardless of a shape of a generated junction shape. In embodiments, a modified generated junction size (for example, modified generated junction size (l₃, w₃)) may be generated by either or both of the junction size generator 314A and/or a user of the user interface 313, such as, in embodiments, similarly to as described else where herein with respect to the generation of generated junction sizes.

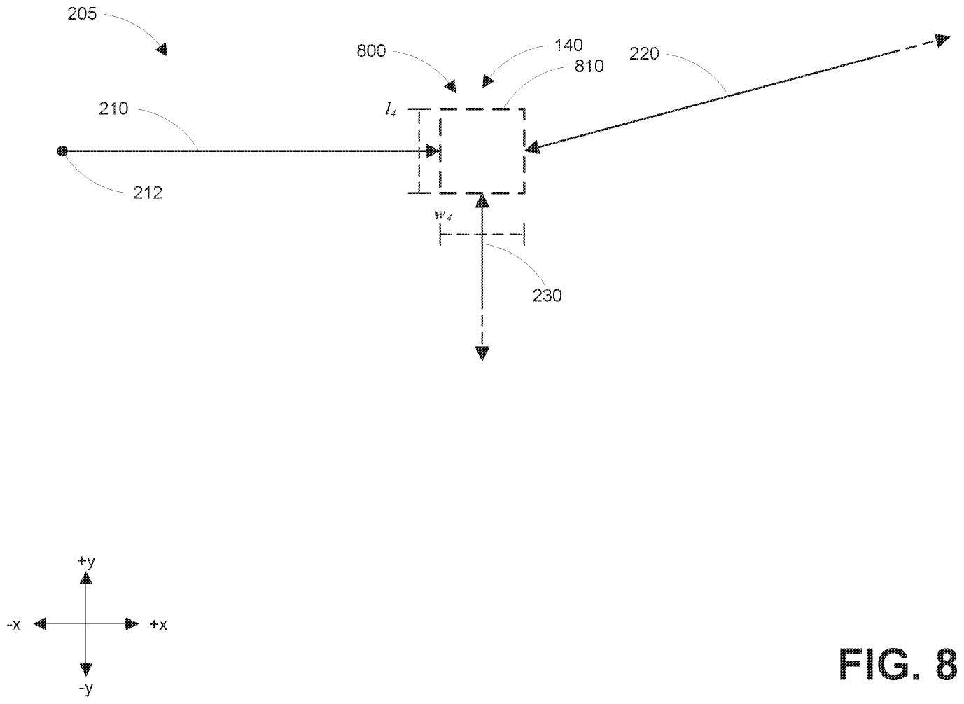

Referring again to FIG. 4 and with reference to FIGS. 7-8, the method 400 may include modifying the road map 200 to comprise the first 2D geospatial boundary 710, as depicted in block 460. In embodiments (for example, in embodiments wherein the road map 200 does not comprise a 2D geospatial boundary of the first road junction 140 prior to initiation of the method 400), the step of the block 460 may comprise modifying the road map 200 to newly comprise the first 2D geospatial boundary 710, for example, as a digital representation of the first road junction 140.

However, referring to FIGS. 7-8, in other embodiments, another road map (for example, a road map 205) may comprise a pre-existing 2D geospatial boundary (for example, a pre-existing 2D geospatial boundary 800) of a road junction (for example, the first road junction 140), the step of the block 460 may include modifying the pre-existing 2D geospatial boundary. In embodiments, a pre-existing 2D geospatial boundary may comprise a pre-existing junction shape and, in certain such embodiments, the step of the block 460 may include determining whether the pre-existing junction shape differs from a generated junction shape generated by the method 400. In embodiments, upon determining that the pre-existing junction shape differs from the generated junction shape (by, for example, exceeding a pre-determined shape deviation threshold), the step of the block 460 may include replacing the pre-existing junction shape with the generated junction shape. For example, since the first generated junction shape 610 is a triangle, while a pre-existing junction shape 810 of the pre-existing 2D geospatial boundary 800 is a square, the method 400 may include, in embodiments, replacing the pre-existing junction shape 810 with the first generated junction shape 610. In embodiments, a pre-existing 2D geospatial boundary may comprise a pre-existing junction size and, in certain such embodiments, the step of the block 460 may include determining whether the pre-existing junction size differs from a generated junction size generated by the method 400. In embodiments, upon determining that the pre-existing junction size differs from the generated junction size (by, for example, exceeding a pre-determined size deviation threshold), the step of the block 460 may include replacing the pre-existing junction size with the generated junction size. For example, since the modified generated junction size (l₃, w₃) differs from a pre-existing junction size (l₄, w₄), the method 400 may include, in embodiments, replacing the pre-existing junction size (l₄, w₄) with the modified generated junction size (l₃, w₃). Accordingly, in embodiments, a step of the block 460 may comprise replacing a pre-existing 2D geospatial boundary with an estimated 2D geospatial boundary in a road map. In embodiments, the step of the block 460 may include any, some, or all of replacing a pre-existing junction size with a generated junction size, replacing a pre-existing junction shape with a generated junction shape, and/or replacing a pre-existing 2D geospatial boundary with an estimated 2D geospatial boundary. Accordingly, in embodiments, the method 400 may be used for either or both of generating one or more new 2D geospatial boundaries in the road map 200 where none previously existed and/or replacing pre-existing 2D geospatial boundaries in the road map 200 (to, for example, account for changes in a road junction or roads defining the road junction since generation of a pre-existing 2D geospatial boundary representing the road junction).

In embodiments, road maps (for example, the road map 200 and/or the road map 205) may be modified by a road map modifier 314C of the subsystems 314 of the computing device 310 and/or of the remote computing device 350. In embodiments, the road map modifier 314C may comprise any, some, or all of an AI algorithm, a neural network, a deep neural network, any other algorithm, and/or any combination thereof for modifying a road map. In embodiments, any, some, or all of the algorithm(s) of the road map modifier 314C may, in embodiments, independently and/or separately from, parallel to, and/or collectively with one or more other algorithms of the road map modifier 314C (if any) modify road maps. In embodiments, the road map modifier 314C may modify road maps (for example, the road map 200 and/or the road map 205) to include a 2D geospatial boundary (for example, the first 2D geospatial boundary 710).

In embodiments, road maps (for example, the road map 200 and/or the road map 205) may be modified by a user of the user interface 313 and, in embodiments, such modifications may be received by any, some, or all of the memory components 311, 351 and/or the road map modifier 314C. In embodiments, road maps (for example, the road map 200 and/or the road map 205) may be modified by one of the road map modifier 314C and/or a user of the user interface 313 separately from, parallel to, or in coordination with the other of the road map modifier 314C or the user of the user interface 313.

In embodiments, road maps (for example, the road map 200 and/or the road map 205) that are modified to comprise one or more 2D geospatial boundaries (for example, either or both of the 2D geospatial boundaries 710, 720) of a road junction (to, for example, newly include the one or more 2D geospatial boundaries and/or modify one or more pre-existing 2D geospatial boundaries) may provide mechanisms for operating a vehicle, such as, for example, navigating a vehicle and/or autonomously driving a vehicle. For example, by providing 2D geospatial boundaries of a road junction in a road map, an autonomous driving system of a vehicle may use the 2D geospatial boundary to navigate the road junction by, for example, incorporating a shape and/or size of the road junction to inform the autonomous driving system's navigation of the road junction. Further, in embodiments wherein a pre-existing 2D geospatial boundary (for example, the pre-existing 2D geospatial boundary 800) is replaced in a road map (for example, the road map 205) by a 2D geospatial boundary (for example, either or both of the 2D geospatial boundaries 710, 720), a road map may be regularly updated. By regularly updating a road map (for example, to incorporate changes made to a road junction and/or one or more roads defining a road junction), vehicle operation may be improved. For example, an autonomous driving system of a vehicle may risk improperly navigating a road junction if the autonomous driving system is using a road map having a pre-existing 2D geospatial boundary which does not reflect changes made to the road junction and/or one or more roads defining the road junction (which may, for example, endanger the vehicle, a driver and/or one or more passengers of the vehicle, and/or other nearby vehicles). However, in embodiments, by providing a mechanism for regularly updating 2D geospatial boundaries, an autonomous driving system of a vehicle may reduce or avoid such risks by reducing the likelihood of a 2D geospatial boundary in a road map being inaccurate (for example, having a size and/or shape that does not reflect changes made to the road junction and/or roads defining the road junction).

It should now be understood that the present disclosure relates to various methods, systems, and non-transitory computer-readable mediums that include estimate a 2D geospatial boundary of a road junction.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for estimating a 2D geospatial boundary of a road junction, the method comprising:
receiving a road map comprising a first road and a second road;
receiving intended use data and geospatial data of the first road and the second road;
identifying a first road edge of the first road and a second road edge of the second road;
identifying the road junction, wherein the road junction is defined by the first road edge and the second road edge;
estimating the 2D geospatial boundary of the road junction, wherein:
the 2D geospatial boundary comprises a generated junction size and a generated junction shape,
the estimating of the 2D geospatial boundary comprises generating the generated junction size using the intended use data of the first road and the intended use data of the second road, and
the estimating of the 2D geospatial boundary comprises generating the generated junction shape using the geospatial data of the first road and the geospatial data of the second road; and
modifying the road map to comprise the 2D geospatial boundary.

2. The method of claim 1, wherein:
the road map further comprises a third road;
the method further comprises identifying a third road edge of the third road;
the road junction is further defined by the third road edge;
the generated junction size is further generated using intended use data of the third road; and
the generated junction shape is further generated using geospatial data of the third road.

3. The method of claim 1, wherein the generated junction size is generated using the geospatial data of the first road, the geospatial data of the second road, or both.

4. The method of claim 1, wherein the generated junction shape is generated using the intended use data of the first road, the intended use data of the second road, the generated junction size, or any combination thereof.

5. The method of claim 1, wherein the intended use data of the first road comprises a first road classification and the intended use data of the second road comprises a second road classification.

6. The method of claim 1, wherein the generating of the generated junction size comprises generating a first offset distance of the first road and a second offset distance of the second road.

7. The method of claim 1, wherein the geospatial data of the first road comprises first coordinates of the first road edge and the geospatial data of the second road comprises second coordinates of the second road edge.

8. The method of claim 1, wherein the geospatial data of the first road comprises a first directional vector and the geospatial data of the second road comprises a second directional vector.

9. The method of claim 1, wherein the modifying of the road map wherein either:
the modifying of the road map comprises modifying the road map to newly comprise the 2D geospatial boundary; or
the modifying of the road map comprises modifying a pre-existing 2D geospatial boundary of the road map, wherein:
the pre-existing 2D geospatial boundary comprises a pre-existing junction size and a pre-existing junction shape,
the modifying of the road map comprises, upon determining that the pre-existing junction size differs from the generated junction size, replacing the pre-existing junction size with the generated junction size, and
the modifying of the road map comprises, upon determining that the pre-existing junction shape differs from the generated junction shape, replacing the pre-existing junction shape with the generated junction shape.

10. A system for road junction 2D geospatial boundary estimation comprising:
a memory component, wherein:
the memory component stores a road map,
the road map comprises a first road and a second road, a first road edge of the first road and a second road edge of the second road, and
the memory component further stores intended use data and geospatial data of the first road and the second road;
a road data interpreter which receives, from the memory component, the first road edge and the second road edge and identifies a road junction defined by the first road edge and the second road edge;
a junction size generator which receives, from the memory component, the intended use data of the first road and the intended use data of the second road and generates a generated junction size using the intended use data of the first road and the intended use data of the second road;
a junction shape generator which receives, from the memory component, the geospatial data of the first road and the geospatial data of the second road and generates a generated junction shape using the geospatial data of the first road and the geospatial data of the second road; and
a road map modifier which receives, from the junction size generator, the generated junction size and, from the junction shape generator, the generated junction shape and modifies the road map to comprise:
the generated junction size,
the generated junction shape, or
the generated junction size and the generated junction shape.

11. The system of claim 10, wherein:
the road map further comprises a third road and a third road edge of the third road;
the memory component further stores intended use data and geospatial data of the third road;
the road junction is further defined by the third road edge;
the junction size generator further receives, from the memory component, the intended use data of the third road and further generates the generated junction size using the intended use data of the third road; and
the junction shape generator further receives, from the memory component, the geospatial data of the third road and further generates the generated junction shape using the geospatial data of the third road.

12. The system of claim 10, wherein the junction size generator generates the generated junction size using the geospatial data of the first road and the geospatial data of the second road.

13. The system of claim 10, wherein the junction shape generator generates the generated junction shape using the intended use data of the first road, the intended use data of the second road, the generated junction size, or any combination thereof.

14. The system of claim 10, wherein the intended use data of the first road comprises a first road classification and the intended use data of the second road comprises a second road classification.

15. The system of claim 10, wherein:
the junction size generator further generates a first offset distance of the first road and a second offset distance of the second road; and
the junction size generator generates the generated junction size using the first offset distance and the second offset distance.

16. The system of claim 10, wherein the geospatial data of the first road comprises first road edge coordinates of the first road edge and the geospatial data of the second road comprises second road edge coordinates of the second road edge.

17. The system of claim 10, wherein the geospatial data of the first road comprises a first directional vector and the geospatial data of the second road comprises a second directional vector.

18. The system of claim 10, wherein either:
the road map modifier modifies the road map to newly comprise a digital representation of the road junction; or
the road map modifier modifies the road map by modifying a pre-existing road junction of the road map, wherein:
the pre-existing road junction comprises a pre-existing junction size and a pre-existing junction shape,
the modifying comprises, upon determining that the pre-existing junction size differs from the generated junction size, replacing the pre-existing junction size with the generated junction size, and
the modifying comprises, upon determining that the pre-existing junction shape differs from the generated junction shape, replacing the pre-existing junction shape with the generated junction shape.

19. The system of claim 10, wherein the memory component either:
receives the road junction from a road junction identifier which identifies the road junction using the first road edge and the second road edge; or
receives the road junction from a user, wherein the user identifies the road junction.

20. A non-transitory computer-readable medium that stores logic that, when executed by a processor, causes the processor to perform at least the following:
receive, from a memory component, a road map comprising a first road, a second road, a first road edge of the first road, a second road edge of the second road edge, and intended use data and geospatial data of the first road and the second road;
identifying, by a road data interpreter, a road junction defined by the first road edge and the second road edge;
estimating a 2D geospatial boundary of the road junction, wherein:
the 2D geospatial boundary comprises a generated junction size and a generated junction shape,
the estimating of the 2D geospatial boundary comprises generating, by a junction size generator, the generated junction size using the intended use data of the first road and the intended use data of the second road, and
the estimating of the 2D geospatial boundary comprises generating, by a junction shape generator, the generated junction shape using the geospatial data of the first road and the geospatial data of the second road; and
modify, by a road map modifier, the road map to comprise the 2D geospatial boundary.
